(19) United States
(12) Patent Application Publication
(10) Pub. No.: US 2026/0027903 A1
(43) Pub. Date: Jan. 29, 2026

(54) VEHICLE DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/192,576

(22) Filed: Apr. 29, 2025

(30) Foreign Application Priority Data
Jul. 25, 2024 (JP) 2024-120348

(51) Int. Cl. B60K 35/81; B60K 35/23; B60K 35/28

(52) U.S. Cl. CPC B60K 35/81; B60K 35/23; B60K 35/28; B60K 2360/171; B60K 2360/178

(57) ABSTRACT

A vehicle display control device includes: a display control unit that displays an own vehicle image depicting the own vehicle and a function image indicating an operation function of the own vehicle on a display region provided in the vicinity of a driver's seat of the own vehicle, and moves a display of the function image in response to an operation on the function image; and a function control unit that controls a state of the operation function corresponding to the operated function image based on a positional relationship between the own vehicle image and the function image.

### CROSS-REFERENCE TO RELATED APPLICATION

This application claims priority to Japanese Patent Application No. 2024-120348 filed on Jul. 25, 2024. The disclosure of the above-identified application, including the specification, drawings, and claims, is incorporated by reference herein in its entirety.

### BACKGROUND

### 1. Technical Field

The technology according to the disclosure relates to a vehicle display control device.

### 2. Description of Related Art

Japanese Patent No. 7048398 (JP 7048398 B) discloses a vehicle control device that is capable of performing automated driving of an own vehicle, such that an occupant thereof is imparted a sense of security. The vehicle control device includes a display unit, a recognition unit, a driving control unit, and a display control unit. The display unit displays images. The recognition unit recognizes objects, including other vehicles. The driving control unit generates a target path of the own vehicle based on states of the objects, and controls at least one of speed or steering of the own vehicle based on the target path. The display control unit causes the display unit to display a first image mimicking another vehicle and a second image mimicking the target path, in a manner superimposed on a third image mimicking a road on which the own vehicle is present. The second image is an image in which, out of a plurality of sections that is obtained by sectioning the target path with respect to the length direction thereof, a first section is displayed in a highlighted manner as compared with a second section. The first section is a section on a near side of a reference vehicle that was referenced when generating the target path, as viewed from the own vehicle. The second section is a section on a far side of the reference vehicle as viewed from the own vehicle.

### SUMMARY

In the technology described in JP 7048398 B, a situation in surroundings of the own vehicle that is recognized by the display unit, and the target path of the own vehicle, are displayed. Now, there is technology that enables a display region to be operated using a touch panel or the like, but there is room for improvement in enabling a state of an operation function (e.g., driving assistance functions or the like) of the own vehicle to be changed by intuitive operations.

An object of the technology according to the disclosure is to provide a vehicle display control device that is capable of changing states of operation functions of an own vehicle by intuitive operations performed with respect to a display region.

A vehicle display control device according to a first aspect includes
a display control unit that displays an own vehicle image depicting an own vehicle and a function image indicating an operation function of the own vehicle, on a display region that is provided in a vicinity of a driver's seat of the own vehicle, and also causes a display of the function image to move in response to an operation that is performed on the function image, and
a function control unit that controls a state of the operation function corresponding to the function image that is operated, based on a positional relation between the own vehicle image and the function image.

Thus, with the vehicle control device according to the first aspect, the state of the operation function of the own vehicle can be changed by intuitive operations that are performed with respect to the display region.

With a vehicle display control device according to a second aspect, in the vehicle display control device according to the first aspect,
the display control unit displays the function image corresponding to the operation function that is disabled, in a first region that is a region in which display is performable when the operation function is disabled, and
when the function image is moved from the first region to a second region that is a region nearby the own vehicle image, the function control unit enables the operation function corresponding to the function image that is moved.

Thus, with the vehicle display control device according to the second aspect, the operation function corresponding to the function image can be enabled, by the operation of bringing the function image, indicating the disabled state, from the first region to closer to the own vehicle image.

With a vehicle display control device according to a third aspect, in the vehicle display control device according to the first or second aspects,
when a predetermined condition for changing the state of the operation function is not satisfied, the function control unit sets the state of the operation function to a state before changing, and
the display control unit displays warning information indicating that the operation function is in the state before changing.

Thus, with the vehicle display control device according to the third aspect, when an attempt is made to change the operation function that does not satisfy the predetermined condition, an occupant can be notified that changing of the operation function failed.

With a vehicle display control device according to a fourth aspect, in the vehicle display control device according to any one of the first to third aspects,
the display control unit displays the function image corresponding to the operation function that is enabled, in a third region that is a region in which display is performable when the operation function is enabled, and
when the function image is moved from the third region, the function control unit disables the operation function corresponding to the function image that is moved.

Thus, with the vehicle display control device according to the fourth aspect, the operation function corresponding to the function image can be disabled by the operation of removing the function image, indicating the enabled state, from the third region.

With a vehicle display control device according to a fifth aspect, in the vehicle display control device according to any one of the first to fourth aspects,
a list of states of one or a plurality of the operation function is displayed, based on an operation that is performed on a predetermined region in surroundings of the own vehicle image.

Thus, with the vehicle display control device according to the fifth aspect, the occupant can recognize the states of the operation functions of the own vehicle in a list.

According to the disclosed technology, the states of the operation functions of the own vehicle can be changed by intuitive operation on the display region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle display control device according to an embodiment;

FIG. 2 is a block diagram illustrating a functional configuration of the vehicle display control device according to the embodiment;

FIG. 3A is a diagram illustrating an example of a display screen of a second display unit according to an embodiment;

FIG. 3B is a diagram illustrating an example of a display screen of a second display unit according to an embodiment;

FIG. 4A is a diagram illustrating an example of a display screen of a second display unit according to an embodiment;

FIG. 4B is a diagram illustrating an example of a display screen of a second display unit according to an embodiment;

FIG. 5 is a flow chart illustrating an exemplary flow of the displaying process according to the embodiment; and

FIG. 6 is a diagram illustrating an example of a display screen of the second display unit according to the embodiment;

### DETAILED DESCRIPTION OF EMBODIMENTS

A vehicle 12 to which the vehicle display control device 10 according to the present embodiment is applied will be described with reference to the drawings. As an example, the vehicle 12 of the present embodiment includes a plurality of driving support functions including a driving support function related to automated driving. The vehicle 12 is an example of an “own vehicle”. The driving assistance function is an example of an “operation function”. The operation function may be a function related to the vehicle 12, and may be any function that can be operated by an occupant of the vehicle 12, for example, a door lock function of the vehicle 12, an opening/closing function of a window, or the like.

Although the driving support functions included in the vehicle 12 of the present embodiment include various driving support functions, the following driving support functions will be described as an example in the present embodiment.

(1) Radar Cruise Control (ACC/DRCC: Adaptive Cruise Control/Dynamic Radar Cruise Control). This function is a driving assistance function of recognizing a preceding vehicle by a camera and a radar (monocular camera and millimeter wave radar) included in a sensor group 42 to be described later and assisting the following traveling while maintaining an inter-vehicle distance corresponding to the vehicle speed.

(2) Lane Tracing Assist (LTA: Lane Tracing Assist). This function supports part of the steering force required to be able to travel in the center of the same lane during ACC control. The use scene is, for example, when traveling on an expressway. During ACC control, a “predetermined condition” is exemplified.

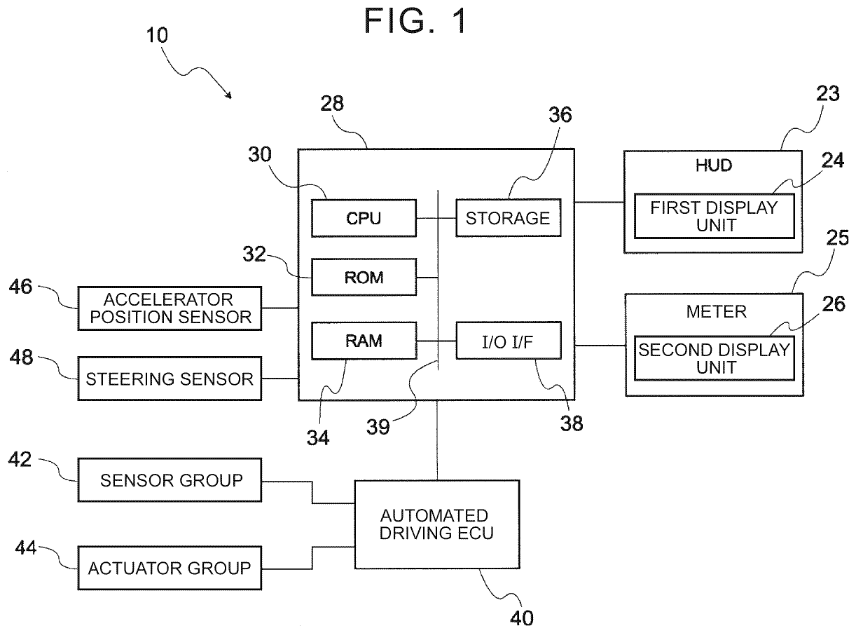

As illustrated in FIG. 1, the vehicle display control device 10 of the present embodiment includes an ECU (Electronic Control Unit) 28.

ECU 28 includes CPU (Central Processing Unit: processor) 30, ROM (Read Only Memory) 32, RAM (Random Access Memory) 34, storage 36, and input/output interface 38. The components are communicably connected to each other via an internal bus 39.

CPU 30 is a central processing unit that executes various programs and controls each unit. That is, CPU 30 reads the program from ROM 32 or the storage 36, and executes the program using RAM 34 as a work region. In addition, CPU 30 performs control of the above-described configurations and various arithmetic processes in accordance with programs recorded in ROM 32 or the storage 36.

The ROM 32 stores various programs and various data. RAM 34 temporarily stores a program/data as a work region. The storage 36 is a non-transitory recording medium configured by HDD (Hard Disk Drive) or SSD (Solid State Drive) and storing various programs including an operating system and various types of data. In the present embodiment, ROM 32 or the storage 36 stores a display program or the like for performing a display process. Various input/output devices are connected to the input/output interface 38. For example, a touch panel (not shown) provided on the second display unit 26 to be described later is connected to the input/output interface 38.

A head-up display (Head-Up Display: HUD) device 23 and a meter 25 are connected to ECU 28. The first display unit 24 is constituted by a projection surface projected by HUD device 23. The second display unit 26 is a display unit displayed on the meter 25, and the meter 25 is located in front of the driver's seat in an instrument panel (not shown) provided in the front portion of the vehicle cabin of the vehicle 12. The first display unit 24 and the second display unit 26 are provided at positions visible to the driver. As described above, the vehicle display control device 10, the first display unit 24, and the second display unit 26 constitute a vehicle display system.

Here, ECU 28 is electrically connected to the automated driving ECU 40. Like ECU 28, the automated driving ECU 40 includes a CPU, ROM, RAM (not shown), a storage, an input/output interface, and the like.

The automated driving ECU 40 is connected with a sensor group 42 for detecting the present condition of the vehicle and an actuator group 44 for controlling the travel of the vehicle. The sensor group 42 includes a plurality of sensors among various sensors such as cameras, radars, lidars (LIDAR; Light Detection and Ranging or Laser Imaging Detection and Ranging), and GPS (global positioning system) sensors. The camera captures an image of the vicinity of the vehicle. The radar detects a distance and a direction from an object in the vicinity of the vehicle by radio waves. The lidar detects a distance and a direction from an object in the vicinity of the vehicle by the laser beam. GPS sensor detects a present position of the vehicle. In addition, the sensor group 42 includes a sensor for detecting the state of the occupant. For example, the sensor group 42 may include a biological sensor that detects a heart rate, an arousal level, and the like of the occupant.

The actuator group 44 includes an acceleration/deceleration actuator for adjusting acceleration/deceleration of the vehicle and a steering actuator for driving a steering device of the vehicle. In the automated driving ECU 40, the automated driving of the vehicle is performed by controlling the operation of the actuator group 44 according to the present condition of the vehicle detected by the sensor group 42. The storage unit of the automated driving ECU 40 stores a scheduled route representing a route on which the vehicle is scheduled to travel, and the automated driving ECU 40 causes the vehicle to travel along the scheduled route stored in the storage unit.

An accelerator position sensor 46 and a steering sensor 48 are connected to ECU 28. The accelerator position sensor 46 is a sensor for detecting a position of an accelerator pedal (not shown) provided at a lower portion of the driver's seat. The steering sensor 48 is a sensor that detects a load applied to the steering wheel 16 by an occupant. That is, the steering sensor 48 of the present embodiment is configured not to detect a load when the steering wheel 16 is operated by the automated driving ECU 40 during automated driving. Further, the steering sensor 48 of the present embodiment is configured to detect a load when the occupant operates the steering wheel 16.

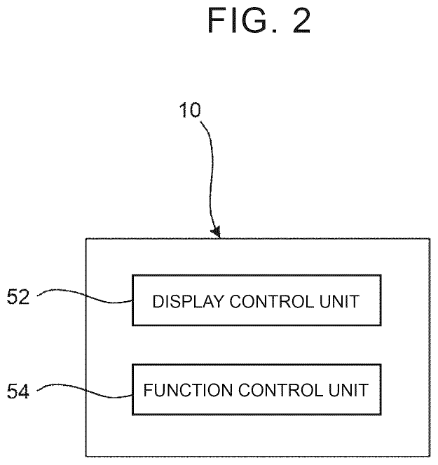

The vehicle display control device 10 realizes various functions using the above-described hardware resources. A functional configuration realized by the vehicle display control device 10 will be described with reference to FIG. 2.

As illustrated in FIG. 2, the vehicle display control device 10 of the present embodiment includes a display control unit 52 and a function control unit 54 as a functional configuration. The respective functional configurations are realized by CPU 30 of ECU 28 reading and executing the programs.

The display control unit 52 has a function of displaying a tell-tale indicating an operation state of the driving assistance function in accordance with the detected gesture operation. For example, the display control unit 52 displays the tell-tale indicating the operating state of the driving assistance function of the vehicle 12 in accordance with the slide operation detected by the touch panel provided on the second display unit 26. Specifically, the operating state includes states such as a stop state in which the function is not activated, a standby state in which the function can be activated, and an activation state in which the function is activated. The standby state is an example of a “disabled” state. The activation state is an example of an “enabled” state. The gesture operation is not limited to a slide operation, and may be any gesture operation such as a single tap operation, a double tap operation, a pinch-in operation, a pinch-out operation, or the like. Note that the gesture operation is not limited to the operation detected by the touch panel, and may be an operation based on information detected by the sensor group 42 (for example, image information indicating movement of a finger of an occupant, or the like). Hereinafter, the tell-tale indicating the operating state of the driving assistance function of the vehicle 12 may be simply referred to as “tell-tale”. The tell-tale is an example of a “functional image”.

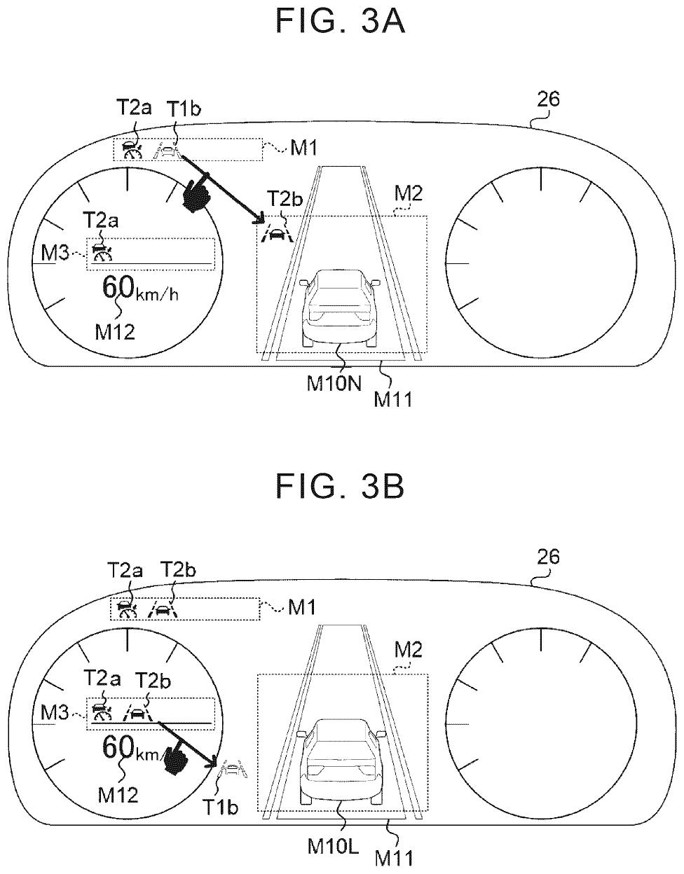

Further, the display control unit 52 has a function of changing the mode of the own vehicle image and displaying the same. The display control unit 52 causes the first display unit 24 and the second display unit 26 to display, for example, by changing the size of the own vehicle image M10 (refer to FIG. 3A and the like) that depicts the vehicle 12. Note that the display control unit 52 is not limited to the size of the own vehicle-image M10, and may change the colors, the decorations, the types of parts (for example, bumpers, side mirrors, and the like) and display them.

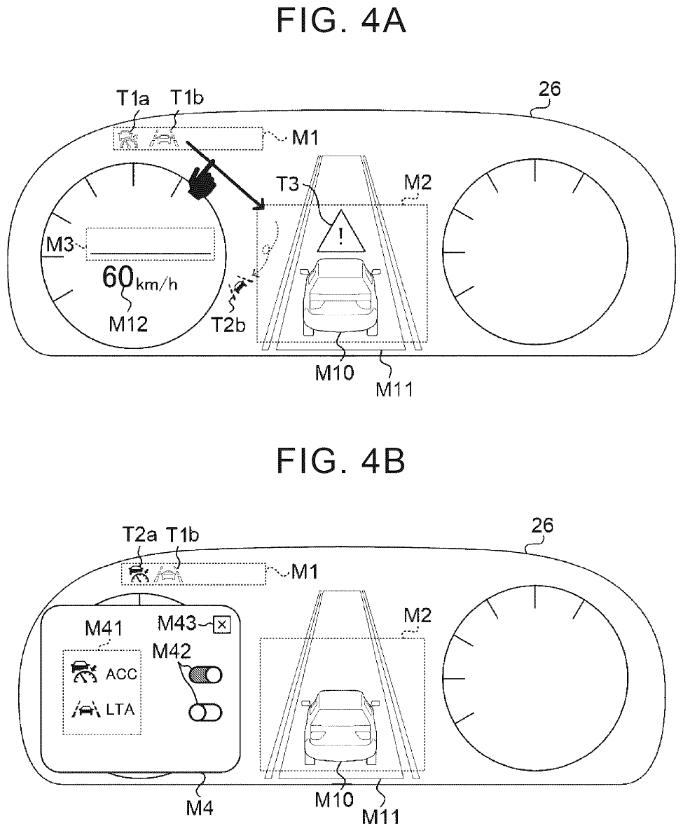

The display control unit 52 has a function of displaying a warning image when the operating state of the driving assistance function cannot be changed. The display control unit 52 causes the first display unit 24 and the second display unit 26 to display a warning image T3 (refer to FIG. 4A), for example, when the driving support function cannot be activated state. Note that the display control unit 52 may display the warning image T3 when the driving support function cannot be put into the standby state. The warning image T3 is an example of “warning information”.

Further, the display control unit 52 has a function of displaying a list of driving support functions in accordance with the detected gesture operation. The display control unit 52 causes the first display unit 24 and the second display unit 26 to display a list display M4 (refer to FIG. 4B), for example, when a double-tap operation is detected on a predetermined region of the second display unit 26.

The function control unit 54 has a function of controlling an operating state of the driving support function. The function control unit 54 controls the operation state of the driving support function of the vehicles 12 via the automated driving ECU 40, for example, by transmitting a signal toward the automated driving ECU 40. Note that the function control unit 54 may directly control the operating state of the driving assistance function of the vehicle 12. The function control unit 54 of the present embodiment changes the operating state of the driving assistance function of the vehicle 12 in accordance with the positional relation between the tell-tale and the own vehicle image M10. However, when the prerequisite is not satisfied, the function control unit 54 does not change the operating state of the driving assistance function of the vehicle 12. Here, the prerequisite refers to an operating state of another function necessary for changing an operating state of a certain function. For example, a prerequisite for bringing LTA into an activated state is an activated state of ACC, and a prerequisite for bringing ACC into an idle state is an idle state of LTA. For example, when ACC is not in the activated state, the function control unit 54 does not set LTA to the activated state. When LTA is not in the standby state, the function control unit 54 does not bring ACC into the standby state. The precondition is an example of a “predetermined condition”. Note that the function control unit 54 may change the control of the operating state of the operation function of the vehicle 12 based on which direction the tell-tale is positioned with respect to the own vehicle image M10. For example, the function control unit 54 may change the operating state of the door lock function on the left side of the vehicle 12 when the tell-tale indicating the door lock function is brought closer to the left side of the own vehicle image M10.

Hereinafter, a part of the display screen displayed in the display region in the second display unit 26 of the present embodiment will be described with reference to FIG. 3A, FIG. 3B, FIG. 4A, and FIG. 4B. FIG. 3A, FIG. 3B, FIG. 4A, and FIG. 4B are diagrams showing display screens that are displayed in a changed manner in response to the detected gesture manipulation. The display region in the second display unit 26 is an example of a “display region”.

As shown in FIG. 3A and FIG. 3B, the second display unit 26 displays an own vehicle image M10 depicting the vehicle 12, a road surface image M11 depicting the traveling lane of the vehicle 12, and a speed display M12 indicating the speed of the vehicle 12. Further, in the second display unit 26, a standby tell-tale T1 which is a tell-tale indicating a standby state and an activation tell-tale T2 which is a tell-tale indicating a start state are displayed. In the second display unit 26, a fixed display region M1 capable of fixed display of the standby tell-tale T1, an own vehicle region M2 capable of displaying the activation tell-tale T2, and an activation region M3 capable of fixed display of the activation tell-tale T2 are set. The fixed display region M1 is an exemplary “first region”. The own vehicle region M2 is an exemplary “second region”. The activation region M3 is an exemplary “third region” and “predetermined region of surroundings”.

The own vehicle image M10 is superimposed on the road surface image M11 at a position below the center of the display region in the second display unit 26. The own vehicle image M10 of the present embodiment includes an own vehicle image M10N of a normal size and an own vehicle image M10L of a large size. In addition, the speed display M12 is displayed at a position substantially in the center in the vertical direction in the leftward direction of the own vehicle image M10. The left-right direction of the present embodiment is the left-right direction of the display region of the second display unit 26, and coincides with the left-right direction with respect to the traveling direction of the vehicle 12. The up-down direction is the up-down direction of the display region of the second display unit 26.

The standby tell-tale T1 is the tell that indicates the standby state, and is displayed at a lower brightness compared to the activation tell-tale T2. The standby tell-tale T1 of the present embodiment includes a standby tell-tale T1a indicating that ACC is in the standby state, and a standby tell-tale T1b indicating that LTA is in the standby state. In addition, the activation tell-tale T2 is a tell-tale indicating the startup state, and is displayed at a higher brightness compared to the standby tell-tale T1. The activation tell-tale T2 of the present embodiment includes an activation tell-tale T2a indicating that ACC is in an activated state, and an activation tell-tale T2b indicating that LTA is in an activated state.

The fixed display region M1 is a region in which the standby tell-tale T1 and the activation tell-tale T2 can be fixed in a row in the left-right direction and displayed. The fixed display region M1 is set at a position on the upper left side of the display region in the second display unit 26. The own vehicle region M2 is a region nearby the own vehicle image M10. The own vehicle region M2 is set at a position at the lower center of the display region in the second display unit 26 and in the vicinity of the own vehicle-image M10. Note that the region nearby the own vehicle image M10 is, for example, a region within a predetermined range from the own vehicle image M10. The activation region M3 is a region in which the activation tell-tale T2 can be displayed while being fixed in a row in the left-right direction. The activation region M3 is set at a position above the speed display M12.

As shown in FIG. 3A, the fixed display region M1 displays an activation tell-tale T2a and a standby tell-tale T1b. In addition, an activation tell-tale T2a is displayed in the activation region M3. Then, the standby tell-tale T1b of the fixed display region M1 is displayed so as to move to the own vehicle region M2 in accordance with the detected sliding manipulation. On the inside of the own vehicle region M2, the standby tell-tale T1b is switched to the activation tell-tale T2b and displayed. Here, a solid arrow in FIG. 3A indicates a direction and a path of the detected slide manipulation.

As described above, the activation tell-tale T2a is displayed in the fixed display region M1 and the activation region M3, thereby indicating that ACC is activated state. Further, the standby tell-tale T1b is moved from the fixed display region M1 to the own vehicle region M2, and is switched to the activation tell-tale T2b and displayed, thereby indicating that LTA is changed from the standby state to the activation state.

As shown in FIG. 3B, the fixed display region M1 displays the activation tell-tale T2a, T2b. In addition, an activation tell-tale T2a, T2b is displayed in the activation region M3. Then, in accordance with the detected slide manipulation, the activation region M3 of the activation tell-tale T2b is displayed so as to move to a region outside the activation region M3. Further, on the outer side of the activation region M3, the activation tell-tale T2b is displayed while being switched to the standby tell-tale T1b. Further, the own vehicle image M10N is displayed while being switched to the own vehicle image M10L which is larger than one time. Here, a solid arrow in FIG. 3B indicates a direction and a path of the detected slide manipulation.

As described above, the activation tell-tale T2a, T2b is displayed in both the fixed display region M1 and the activation region M3, thereby indicating that ACC and LTA are activated. In addition, the activation tell-tale T2b is moved from the activation region M3, and is switched to the standby tell-tale T1b and displayed, thereby indicating that LTA is changed from the activation state to the standby state. When the own vehicle-image M10L is displayed, it indicates that the number of driving support functions that are in the activated state is increased as compared with the state in FIG. 3A.

As shown in FIG. 4A, a standby tell-tale T1a, T1b is displayed in the fixed display region M1. Further, in the own vehicle region M2, a warning-image T3 indicating that the operation state of the driving assistance function cannot be changed is displayed. Then, after the standby tell-tale T1b of the fixed display region M1 has moved to the own vehicle region M2 in accordance with the detected slide manipulation, the activation tell-tale T2b is displayed so as to be played from the own vehicle region M2. Here, a solid arrow in FIG. 4A indicates a direction and a path of the detected slide manipulation. In addition, a dashed arrow indicates a moving direction and a path of the tell-tale displayed so as to be bulleted from the own vehicle region M2.

As described above, the standby tell-tale T1a, T1b is displayed in the fixed display region M1, thereby indicating that ACC and LTA are in the standby state. In addition, the warning image T3 is displayed in the own vehicle region, and the activation tell-tale T2b is displayed so as to be played from the own vehicle region M2, so that ACC is not in the activated state, and thus LTA cannot be changed from the standby state to the activated state.

As shown in FIG. 4B, a list display M4 for displaying a list of driving assistance functions of the vehicles 12 is displayed in a left region of the second display unit 26. The list display M4 includes a name region M41 for displaying the tell-tale and the name of the driving support function, a change button M42 capable of changing the operating state of the respective driving support functions, and a close button M43 capable of hiding the list display M4.

Here, in the name region M41, the names of the tell-tale indicating ACC and the “ACC” are displayed in the first row, and the names of the tell-tale indicating LTA and the “LTA” are displayed in the second row. In addition, the change-button M42 is displayed in a state in which the first stage is on and in a state in which the second stage is off. The close-button M43 is displayed in the upper-right corner of the list display M4. In addition, an activation tell-tale T2a and a standby tell-tale T1b are displayed in the fixed display region M1.

As described above, the tell-tale and the name indicating ACC are displayed in the first row of the list display M4, the first row of the change-button M42 is displayed in the ON-state, and the activation tell-tale T2a is displayed in the fixed display region M1, thereby indicating that ACC is in the start-up state. Further, the tell-tale and the name indicating LTA are displayed in the second row of the list display M4, the second row of the change-button M42 is displayed in the off-state, and the standby tell-tale T1b is displayed in the fixed display region M1, thereby indicating that LTA is in the standby state. When the change button M42 is pressed, the operation state of the driving support function corresponding to the pressed change button M42 may be changed.

Note that, in the description of FIG. 3A, FIG. 3B, FIG. 4A, and FIG. 4B, an example of a display screen displayed in a display region in the second display unit 26 has been described, but in the present embodiment, a display screen may be displayed on at least one of the first display unit 24 and the second display unit 26. When the display region of the first display unit 24 is narrower than the display region of the second display unit 26, a part of the image of the second display unit 26 may be displayed on the first display unit 24.

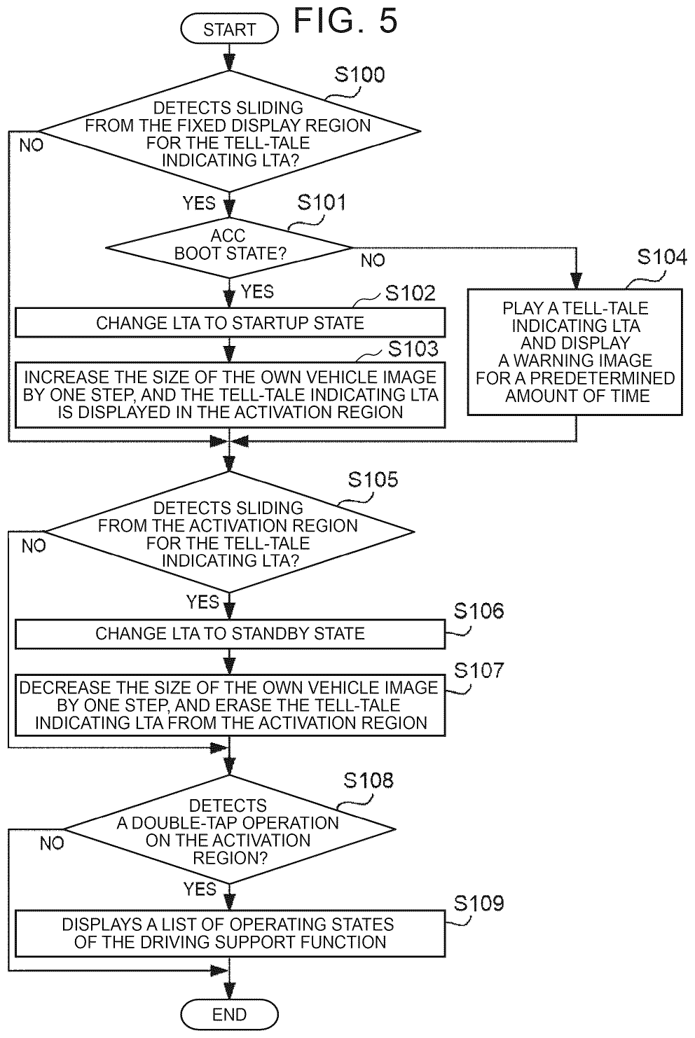

FIG. 5 is a flowchart illustrating an example of a flow of a display process according to the present embodiment. The displaying process is executed by CPU 30 of ECU 28 reading the program from ROM 32 or the storage 36, expanding the program in RAM 34, and executing the program. The display process is executed when CPU 30 functions as the display control unit 52 and the function control unit 54. The display process illustrated in FIG. 5 is, for example, a process that is repeatedly executed while the vehicle 12 is traveling.

In S100 of FIG. 5, CPU 30 determines whether or not a slide manipulation from the fixed display region M1 with respect to the tell-tale indicating LTA has been detected. Specifically, CPU 30 determines whether or not a slide manipulation (refer to FIG. 3A) from the fixed display region M1 to the standby tell-tale T1b indicating LTA to the own vehicle region M2 has been detected. If CPU 30 determines that a slide manipulation from the fixed display region M1 with respect to the tell-tale indicating LTA has been detected (S100: YES), the process proceeds to S101. On the other hand, when CPU 30 determines that the slide manipulation from the fixed display region M1 with respect to the tell-tale indicating LTA has not been detected (S100: NO), the process proceeds to S104.

In S101, CPU 30 determines whether or not ACC is active (i.e., during ACC control). CPU 30 proceeds to S102 when it is determined that ACC is activated state (S101: YES). Meanwhile. If CPU 30 determines that ACC is not activated state (S101: NO), it proceeds to S106.

In S102, CPU 30 changes LTA to an activated state. Specifically, CPU 30 changes LTA from the standby state to the activation state.

In S103, CPU 30 increases the size of the own vehicle image M10 by one step, and displays the tell-tale indicating LTA in the activation region. Specifically, CPU 30 switches the own vehicle image M10N to the own vehicle image M10L, and displays an activation tell-tale T2b indicating LTA in the activation region M3. Further, CPU 30 switches the standby tell-tale T1b indicating LTA displayed in the fixed display region M1 to the activation tell-tale T2b and displays it.

In S104, CPU 30 displays to play the tell-tale indicating LTA and displays T3 of alert images for a predetermined period of time. You do. Specifically, CPU 30 displays, from the own vehicle region M2, an activation tell-tale T2b indicating an LTA displayed so as to move to the own vehicle region M2 in accordance with the slide manipulation of the occupant (refer to FIG. 4A). In addition, CPU 30 displays a warning image T3 for 5 seconds (refer to FIG. 4A).

In S105, CPU 30 determines whether or not a slide manipulation from the activation region M3 with respect to the tell-tale indicating LTA has been detected. Specifically, CPU 30 determines whether or not a slide manipulation (refer to FIG. 3B) from the activation region M3 to the activation tell-tale T2b indicating LTA to a region outside the activation region M3 has been detected. When CPU 30 determines that a slide manipulation from the activation region M3 with respect to the tell-tale indicating LTA has been detected (S105: YES), the process proceeds to S106. On the other hand, when CPU 30 determines that the slide manipulation from the activation region M3 with respect to the tell-tale indicating LTA has not been detected (S105: NO), the process proceeds to S108.

In S106, CPU 30 changes LTA to standby state. Specifically, CPU 30 changes LTA from the activation state to the standby state.

In S107, CPU 30 reduces the size of the own vehicle image M10 by one step, and deletes the tell-tale indicating LTA from the activation region M3. Specifically, CPU 30 switches the own vehicle image M10L to the own vehicle image M10N, and erases the activation tell-tale T2b indicating LTA from the activation region M3. Further, CPU 30 switches the activation tell-tale T2b indicating LTA of the fixed display region M1 to the standby tell-tale T1b and displays it.

In S108, CPU 30 determines whether a double-tap action on the activation region M3 has been detected. If CPU 30 determines that a double-tap action on the activation region M3 has been detected (S108: YES), it proceeds to S109. On the other hand, when CPU 30 determines that the double-tap operation for the activation region M3 has not been detected (S108: NO), the displaying process is ended.

In S109, CPU 30 displays a list of operating states of the driving assistance function. Specifically, CPU 30 displays a list display M4 (refer to FIG. 4B). Then, CPU 30 ends the displaying process. CPU 30 may not display the list of operating states by detecting that the close-button M43 included in the displayed list of operating states has been pressed.

The vehicle display control device 10 of the present embodiment causes the display region of the second display unit provided in the vicinity of the driver's seat of the vehicle 12 to display the own vehicle image M10 and the tell-tale indicating the operating state of the driving assistance function. At the same time, the vehicle display control device 10 of the present embodiment moves the display of the tell-tale according to the sliding operation with respect to the tell-tale, and changes the operation state of the driving support function corresponding to the tell-tale based on the positional relation between the own vehicle image M10 and the tell-tale. Therefore, according to the vehicle display control device 10 of the present embodiment, it is possible to change the state of the operation function of the own vehicle by intuitive operation on the display region.

The vehicle display control device 10 of the present embodiment causes the fixed display region M1 to display a tell-tale indicating the driving support function in the standby state. Further, the vehicle display control device 10 according to the present embodiment activates the driving assistance function corresponding to the tell-tale when the tell-tale is moved from the fixed display region M1 to the own vehicle region M2. Therefore, according to the vehicle display control device 10 of the present embodiment, it is possible to change the driving support function corresponding to the standby tell-tale T1 to the activation state by moving the standby tell-tale T1 from the fixed display region M1 closer to the own vehicle image M10.

When ACC is not in the activated state, the vehicle display control device 10 of the present embodiment keeps LTA in the standby state even when the tell-tale indicating LTA is moved from the fixed display region M1 to the own vehicle region M2, and causes the own vehicle region M2 to display the warning image T3. Therefore, according to the vehicle display control device 10 of the present embodiment, it is possible to notify the occupant that the driving support function cannot be set to the activation state when the driving support function that does not satisfy the prerequisite is set to the activation state.

The vehicle display control device 10 of the present embodiment causes the activation region M3 to display the tell-tale corresponding to the driving assistance function that is the activation state. Further, when the tell-tale is moved from the activation region M3 to a region other than the own vehicle region M2, the vehicle display control device 10 of the present embodiment changes the driving assistance function corresponding to the moved tell-tale to the standby state. Therefore, according to the vehicle display control device 10 of the present embodiment, it is possible to change the driving support function corresponding to the activation tell-tale T2 to the standby state by moving the activation tell-tale T2 from the activation region M3.

The vehicle display control device 10 according to the present embodiment displays a list of operating states of a plurality of driving support functions by double-tapping the activation region M3. Therefore, according to the vehicle display control device 10 of the present embodiment, it is possible to cause the occupant to recognize the operating state of the driving support function of the vehicle 12 in a list.

### OTHER EMBODIMENTS

In the above-described embodiment, (1) ACC and (2) LTA driving support functions have been exemplified, but the driving support functions of the present embodiment are not limited thereto. The driving support function of the present embodiment includes, for example, the following driving support functions.

(3) Lane departure alert (LDA: Lane Departure Alert). When the system determines that the vehicle may deviate from the lane, the function prompts the driver to perform a deviation avoidance operation by notifying the vehicle by a display, a buzzer, or a steering vibration. Further, the lane departure suppression is assisted by the addition of the steering force to the steering wheel and the display.

(4) Automatic high beam (AHB: Automatic High Beam). This function is a system in which a high beam is turned on in a normal state to secure a far field of view, a vehicle light in front is detected when an oncoming vehicle or the like comes, and a high/low state of a headlamp is automatically switched. The use scene is, for example, nighttime traveling.

(5) Driver error response (EDSS: Emergency Driving Stop System). The function is a function of determining whether the state of the driver is normal or abnormal, and, when it is determined that the driver is abnormal, performing stop control in the lane while notifying the outside of the vehicle. It is also envisaged that EDSS can be operated in an expanded manner. Conventionally, only expressways have been supported, but the system can also be applied to general roads in an expanded manner. In addition, in the related art, EDSS is activated only when a driver-abnormal condition is detected during LTA operation, but EDSS is supported even when LTA is not activated, The use scene is, for example, when traveling on a general road or an expressway.

(6) Lane Agent Assist (LCA: Lane Change Assist). In this function, lane change support is started by the driver's turn-over operation. In addition, steering assistance and vicinity monitoring assistance are performed during lane change, and the winker is automatically turned off after lane change. The use scene is, for example, when traveling on an expressway.

(7) Panoramic View Monitor (PVM: Panoramic View Monitor). This function displays a bird's-eye viewpoint on a monitor using images captured by four cameras, front, rear, left, and right, and supports a driving scene with many blind spots. In addition, it uses three-dimensional image expressions (indoor and outdoor viewpoints, slip-through painting, inclusion painting) to support a wider driving scene. It can be designed with an interface design that allows the user to freely operate the viewpoint like a smart device. As a result, it is possible to support the confirmation of the vicinity region which has not been reached by the conventional system. The use scene is, for example, parking backward, backward exit, low-speed movement, or the like.

(8) Advanced Park (AP: Advanced Park). This function detects the parking position by the ultrasonic sonar, front, rear, left, and right cameras, and the driver instructs the parking position displayed on the multimedia, thereby automatically placing the parking garage and assisting the parking from the parking state. The automatic operation operates the accelerator, brake, steering, and shift. Further, it may have a path storage function. Route memory functions support a variety of environments by parking along a stored route. Provide reliable support by following the same path as the driver. The system searches/detects the registered route and proposes the use to the driver to improve the initial usage rate and the continuation rate. Scene used, for example, when parking, at the time of delivery.

(9) Blind spot monitor (BSM: Blind Spot Monitor)/BSM (Long). The function recognizes the vehicle present in the rear side area and assists in checking the vicinity safety at the time of lane change by turning on/off the door mirror indicator. In addition, BSM (Long) can be set. The function of the entrainment alarm is also assumed. Detects bicycles and small motorcycles traveling on the sides of the bicycle, and alarms are given when turning right and left. The use scene is, for example, at the time of lane change.

(10) Advanced drive (AD: Advanced Drive). This function is an advanced driving assistance function that performs steering and acceleration/deceleration control under driver monitoring on an automotive road (hands-off of the automated driving Lv2 is enabled). It is expected to reduce the operating load during long-time and long-distance operation. In addition, lane change is supported toward a destination by overtaking and car navigation cooperation by self-vehicle position identification of a lane level using a high-precision map. The use scene is, for example, when the vehicle is traveling on a road dedicated to automobiles (in some countries such as North America, a general highway is also assumed).

(11) Trailer driving assistance (T-ADAS: Trailer Driving Assist). This function is a generic term for various functions related to the trailer driving support. The functions are T-DRCC, T-PCS (Trailer Pre-Collision System), T-LDA, T-BSM, TBG (Trailer Backup Guide), and T-PVM. T-DRCC adjusts the acceleration/deceleration during the use of ACC to the optimum during the talking even when the weight of the vehicle changes during the talking. T-PCS adjusts the timing of the alarm and the braking control to the optimum during the towing even when the weight of the vehicle changes during the towing. T-LDA is a function of detecting a possibility of a lane/off-road deviation even during towing, and suppressing the deviation by operating the steering. T-BSM expands the detection area so as to be able to detect the vicinity of the rear end of the bumper of the towing vehicle when the trailer is towed, thereby reducing the collision-risk at the time of lane change. TBG realizes retreat support at the time of trailer traction by steering assist. T-PVM is a PVM function specialized for trailer towing or trucking.

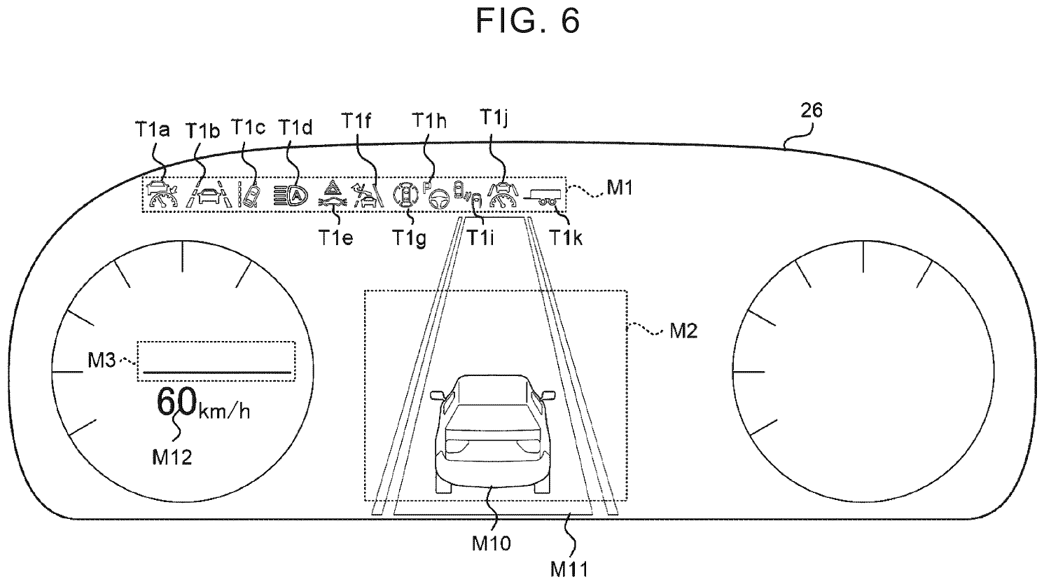

Hereinafter, a display example of the second display unit 26 when the various driving support functions described above are applied to the vehicle display control device 10 of the present embodiment will be described with reference to FIG. 6.

As shown in FIG. 6, in the fixed display region M1, the standby tell-tale T1a to the standby tell-tale T1k are displayed. In the tell-tale of the present embodiment, a tell-tale corresponding to each of the driving support functions described above is prepared. For example, the standby tell-tale T1c is a standby tell-tale T1 corresponding to LDA. The standby tell-tale T1d is a standby tell-tale T1 corresponding to AHB. The standby tell-tale T1e is EDSS, and the standby tell-tale T1f is the standby tell-tale T1 corresponding to LCA. The standby tell-tale T1g is a standby tell-tale T1 corresponding to PVM. The standby tell-tale T1h is a standby tell-tale T1 corresponding to AP. The standby tell-tale Tli is a standby tell-tale T1 corresponding to BSM. The standby tell-tale T1j is a standby tell-tale T1 corresponding to AD. And the standby tell-tale T1k is a standby tell-tale T1 corresponding to T-ADAS. Further, although not shown, an activation tell-tale T2 corresponding to the respective driving support functions is also prepared. Therefore, according to the vehicle display control device 10 of the present embodiment, it is possible to change the operating states of various driving support functions.

In addition, the configuration of the vehicle display control device 10 described in the above embodiment is an example, and may be changed in accordance with a situation within a range not departing from the gist.

The flow of the processing of the program described in the above embodiment is also an example, and unnecessary steps may be deleted, new steps may be added, or the processing order may be changed without departing from the gist.

In the above embodiment, CPU refers to a broad processor. CPU includes a general-purpose processor and a dedicated processor. A general-purpose processor is, for example, a CPU (Central Processing Unit). Dedicated processors are, for example, GPU (Graphics Processing Unit) or ASIC (Application Specific Integrated Circuit). Further, the dedicated processor is, for example, an FPGA (Field Programmable Gate Array), a programmable logic device, or the like.

In addition, the operation of the processor in the above-described embodiment may be performed not only by one processor but also by a plurality of processors that are physically separated from each other. Further, the order of the operations of the processor is not limited to the order described in the above embodiment, and may be changed as appropriate.

In the above-described embodiment, the information processing program is stored (installed) in the storage in advance, but the present disclosure is not limited thereto. The program may be provided in a form recorded on a recording medium. The storage medium is, for example, CD-ROM (Compact Disc Read Only Memory), DVD-ROM (Digital Versatile Disc Read Only Memory), and USB (Universal Serial Bus). The program may be downloaded from an external device via a network. Further, the present disclosure is also applicable to programs and program products.

What is claimed is:

1. A vehicle display control device comprising:
a display control unit that displays an own vehicle image depicting an own vehicle and a function image indicating an operation function of the own vehicle, on a display region that is provided in a vicinity of a driver's seat of the own vehicle, and also causes a display of the function image to move in response to an operation that is performed on the function image; and
a function control unit that controls a state of the operation function corresponding to the function image that is operated, based on a positional relation between the own vehicle image and the function image.

2. The vehicle display control device according to claim 1, wherein:
the display control unit displays the function image corresponding to the operation function that is disabled, in a first region that is a region in which display is performable when the operation function is disabled; and
when the function image is moved from the first region to a second region that is a region nearby the own vehicle image, the function control unit enables the operation function corresponding to the function image that is moved.

3. The vehicle display control device according to claim 1, wherein:
when a predetermined condition for changing the state of the operation function is not satisfied, the function control unit sets the state of the operation function to a state before changing; and
the display control unit displays warning information indicating that the operation function is in the state before changing.

4. The vehicle display control device according to claim 1, wherein:
the display control unit displays the function image corresponding to the operation function that is enabled, in a third region that is a region in which display is performable when the operation function is enabled; and
when the function image is moved from the third region, the function control unit disables the operation function corresponding to the function image that is moved.

5. The vehicle display control device according to claim 1, wherein the display control unit displays a list of states of one or a plurality of the operation function, based on an operation that is performed on a predetermined region in surroundings of the own vehicle image.
